(19) United States
(12) Patent Application Publication
(10) Pub. No.: US 2025/0185624 A1
(43) Pub. Date: Jun. 12, 2025

(54) Pet Licking Mat

(71) Applicants: Ellis N. Shamoon, Dallas, TX (US); Lawrence J. Yeung, Flower Mound, TX (US); Thomas B. Murphy, Arlington, TX (US)

(72) Inventors: Ellis N. Shamoon, Dallas, TX (US); Lawrence J. Yeung, Flower Mound, TX (US); Thomas B. Murphy, Arlington, TX (US)

(21) Appl. No.: 18/531,694

(22) Filed: Dec. 7, 2023

(51) Int. Cl. A01K 5/01

(52) U.S. Cl. CPC A01K 5/0135

(57) ABSTRACT

The present invention is a pet licking mat with an improved nub shape composed of a nub base and plurality of nub extensions. A catchment tray extends below the nubs to prevent food dropping from the device.

### BACKGROUND OF THE INVENTION

### Field of the Invention

The present invention relates to pet care devices, and in particular related to mats providing a licking surface.

### Description of the Background Art

A pet licking mat is a known type of pet care device, and helps calm and soothe a pet, such as a dog, by helping release endorphins through the promotion of licking. Pets under stress will naturally lick almost any available surface, including their own fur or skin which can cause fur loss or skin sores. A specially-provided licking mat provides a safe licking alternative for a pet. Pet licking mats are soothing during stressful times such as vet visits, bath time, nail clipping, and injury recovery, as well as during thunderstorms and fireworks. Just as people can feel stressed or nervous and sometimes bite their nails, dogs use licking to deal with powerful emotions, especially when they cannot control a situation-like during a visit to the veterinarian.

A pet licking mat is also useful for providing a benign activity for easily-bored pets. Pet licking mats are also useful as slow feeders for pets that otherwise gulp meals. Licking mats provide mental stimulation and entertainment like a puzzle toy, as well as aid oral health and help with crate training.

The prior art includes a licking mat made of flexible plastic or silicone, with little patterned raised nubs or bristles on one side of a flat or bowl-shaped surface. The textured surface holds soft treats on and between the nubs to encourage sniffing and licking. The texture not only holds the treat, but it also slows the pet's ability to lick it off and prolongs the pet's enjoyment.

Any food that is “smearable” can be put on a pet licking mat, and some common choices are: peanut butter, aerosol cheese, yogurt, canned dog and cat food, fish paste, and baby food (such as pureed meat or sweet vegetables like carrots or sweet potato).

A common problem with prior art pet licking mats is that smeared food often is dislodged from a vertically-mounted mat and falls to the surface below, making a mess in the bathing vessel or on the examination table, for example, below. No prior art mat provides an integral catchment tray to contain such dislodged particles. Another problem with prior devices is that the nubs are too big to securely engage the food. The licking function is therefore shortened in duration and requires frequent re-smearing.

A need therefore exists for an improved pet licking mat that catches dislodged food when used vertically and securely engages food for long licking sessions.

### SUMMARY OF THE INVENTION

The present invention provides a solution to the problems of the prior art pet licking mat devices by providing a catchment tray integrally molded into the mat and a novel nub construction having a plurality of nub extensions projecting from each nub base in an array of nubs.

### BRIEF DESCRIPTION OF THE DRAWINGS

A more complete understanding of the invention and its advantages will be apparent from the Detailed Description taken in conjunction with the accompanying Drawings, in which:

FIG. 1 is a top right perspective view of pet licking mat constructed in accordance with the invention;

FIG. 2 is a bottom right perspective view of the pet licking mat of FIG. 1;

FIG. 3 is a front elevation view of the pet licking mat;

FIG. 4 is a rear elevation view of the pet licking mat;

FIG. 5 is a top plan of the pet licking mat;

FIG. 6 is a bottom view of the pet licking mat;

FIG. 7 is a right side view, the left side view being a mirror image thereof; and

FIG. 8 is an enlarged view of the dashed line enclosure of FIG. 1.

### DETAILED DESCRIPTION OF THE INVENTION

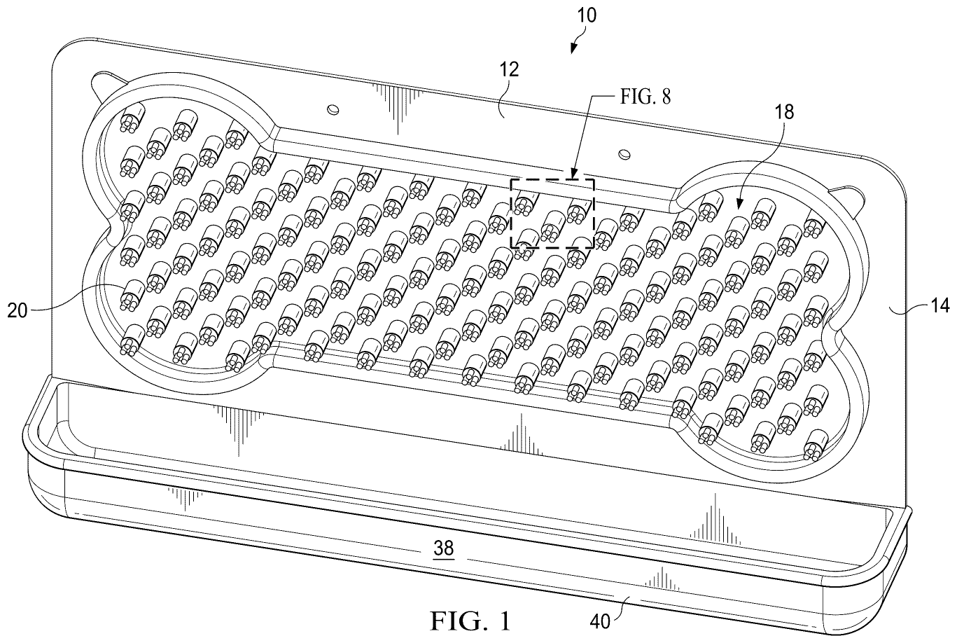

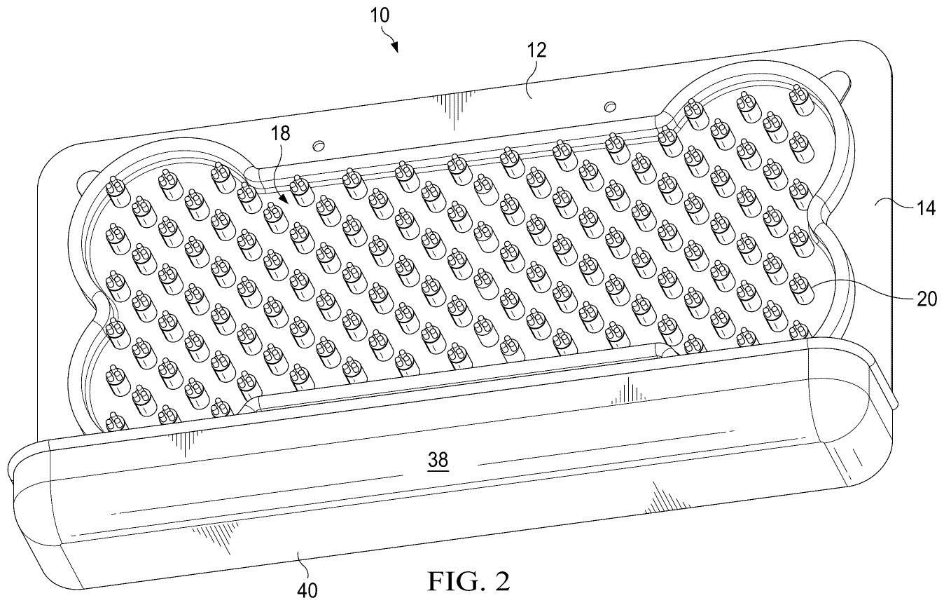

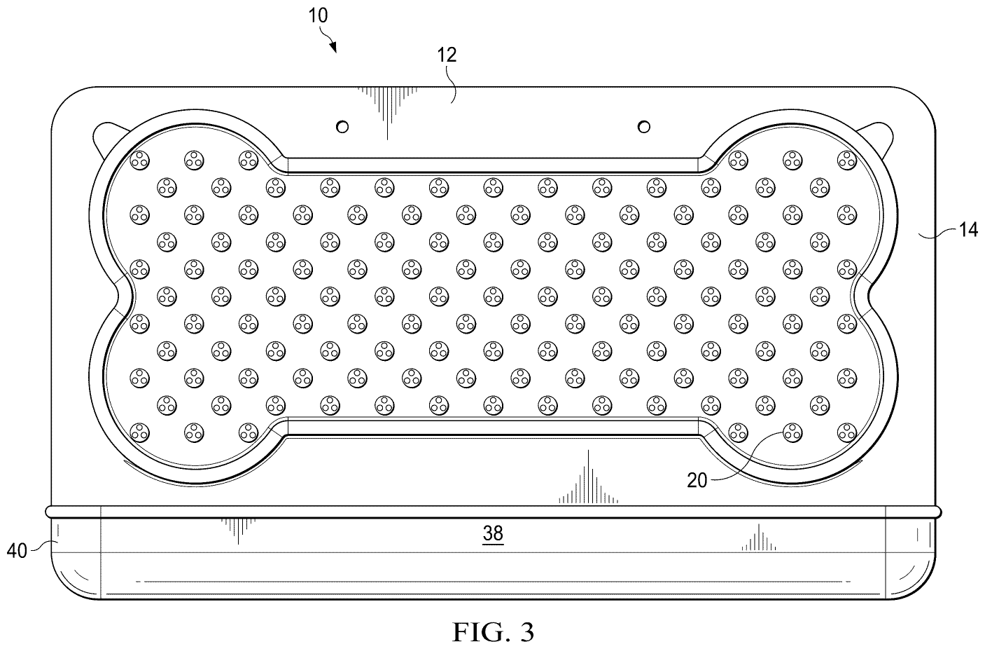

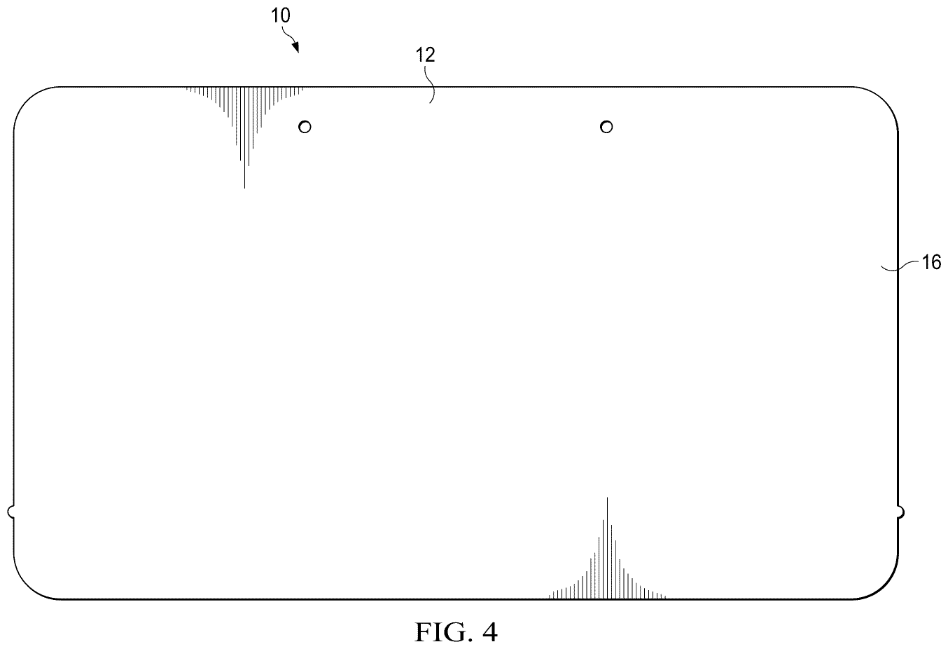

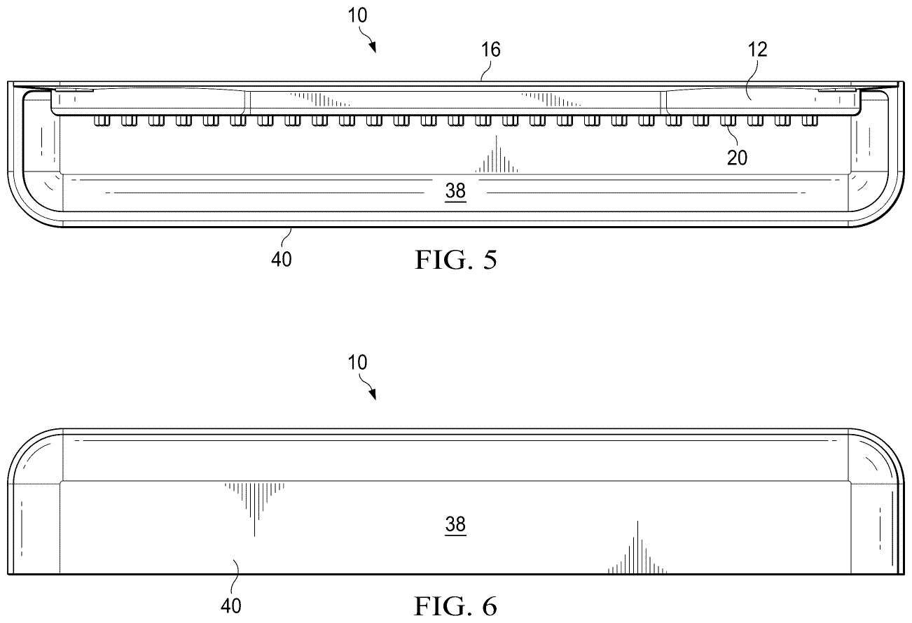

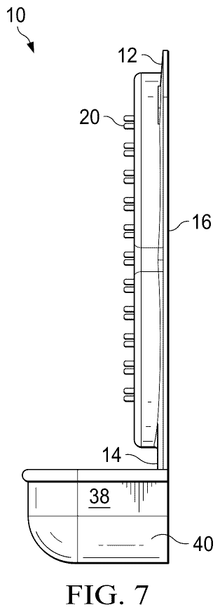

Referring to FIGS. 1-8, where like numerals indicate like and corresponding elements, a pet licking mat 10 has a base 12 formed of silicone rubber and having a front side 14 and a back side 16.

The back side 16 of the base 12 is entirely smooth to enable adhesion to a vertical planar surface (not shown).

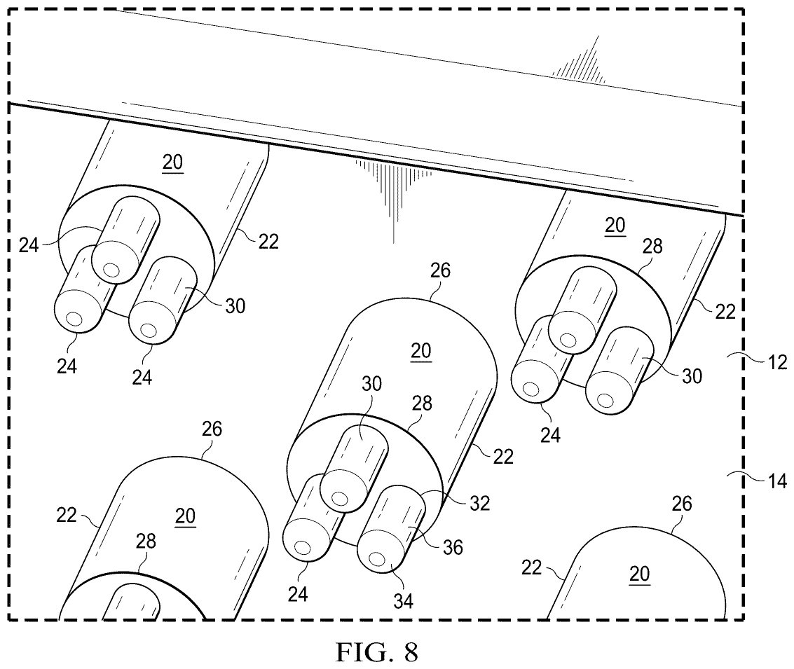

The front side 14 of the base 12 has a nub array 18 formed of a plurality of spaced nubs 20 extending outwardly from the front side 14 and perpendicular to the front side 14. As best shown in FIG. 8, each nub 20 is formed of a nub base 22 and a plurality of nub extensions 24. Each nub base 22 is a solid cylinder with inner and outer ends 26, 28 and a cylindrical side wall 30. Bach nub base 22 is connected at the inner end 26 to the front side 14, with the cylindrical side wall 30 extending from the inner end 26 to the outer end 28, and the outer end 28 being planar, circular, and perpendicular to the cylindrical side wall 30. The plurality of nub extensions 24 of each nub 20 extend outwardly from the nub base outer end 28. Each nub extension 24 is a solid cylinder with an inner end 32, a hemispherical outer end 34, and a cylindrical side wall 36.

A catchment tray 38 extends outwardly from the front side 14 of the base 12. The catchment tray 38 has walls 40 forming and open-topped container below the nub array 18.

In operation, the construction of the nubs with nub bases and nub extensions enables improved retainment of food and longer licking episodes. The catchment tray prevents foods from dropping from the device.

Whereas, the present invention has been described with respect to a specific embodiment thereof, it will be understood that various changes and modifications will be suggested to one skilled in the art, and it is intended to encompass such changes and modifications as fall within the scope of the appended claims.

We claim:

1. A pet licking mat, comprising a nub array formed of a plurality of spaced nubs, with each nub being formed of a nub base and a plurality of nub extensions extending from the nub base.

2. The pet licking mat of claim 2 with a base formed of silicone rubber and having a front side and a back side, the back side of the base being entirely smooth to enable adhesion to a vertical planar surface.

3. The pet licking mat of claim 2 the nub array extending outwardly from the front side and perpendicular to the front side.

4. The pet licking mat of claim 2 with each nub base being a solid cylinder with inner and outer ends and a cylindrical side wall; and
each nub base being connected at the inner end to the front side, with the cylindrical side wall extending from the inner end to the outer end, and the outer end being planar, circular, and perpendicular to the cylindrical side wall.

5. The pet licking mat of claim 4 with the plurality of nub extensions extending outwardly from the nub base outer end, each nub extension being a solid cylinder with an inner end, a hemispherical outer end, and a cylindrical side wall.

6. A pet licking mat comprising a base with a front side and a nub array formed of a plurality of spaced nubs, and a catchment tray extending outwardly from the front side of the base, the catchment tray having walls forming and open-topped container below the nub array.

7. A pet licking mat, comprising:
a base formed of silicone rubber and having a front side and a back side;
the back side of the base being entirely smooth to enable adhesion to a vertical planar surface;
the front side of the base having a nub array formed of a plurality of spaced nubs extending outwardly from the front side and perpendicular to the front side;
each nub being formed of a nub base and a plurality of nub extensions, each nub base being a solid cylinder with inner and outer ends and a cylindrical side wall;
each nub base being connected at the inner end to the front side, with the cylindrical side wall extending from the inner end to the outer end, and the outer end being planar, circular, and perpendicular to the cylindrical side wall;
the plurality of nub extensions extending outwardly from the nub base outer end, each nub extension being a solid cylinder with an inner end, a hemispherical outer end, and a cylindrical side wall; and
a catchment tray extending outwardly from the front side of the base, the catchment tray having walls forming and open-topped container below the nub array.
